(19) United States
(12) Patent Application Publication
(10) Pub. No.: US 2012/0154091 A1
(43) Pub. Date: Jun. 21, 2012

(54) INTEGRATED ELECTROMAGNETIC INTERFERENCE FILTER

(75) Inventors: Jae Sun WON, Suwon (KR); Young Min LEE, Suwon (KR); Deuk Hoon KIM, Incheon (KR); Jong Hae KIM, Suwon (KR); Don Sik KIM, Gunpo, Gyunggi-do (KR); Geun Young PARK, Suwon (KR)

(73) Assignee: SAMSUNG ELECTRO-MECHANICS CO., LTD., Suwon (KR)

(21) Appl. No.: 13/090,725

(22) Filed: Apr. 20, 2011

(30) Foreign Application Priority Data
Dec. 16, 2010 (KR) 1020100129044

(51) Int. Cl. H01F 27/28

(52) U.S. Cl. 336/170

(57) ABSTRACT

Disclosed is an integrated electromagnetic interference filter capable of providing a leakage inductance sufficient to filter the differential mode electromagnetic interference by integrating four inductors for interference filtering in one core structure and controlling the coupling degree between the four inductors for interference filter.

### CROSS-REFERENCE TO RELATED APPLICATIONS

This application claims the priority of Korean Parent Application No. 10-2010-0129044 filed on Dec. 16, 2010, in the Korean Intellectual Property Office, the disclosure of which is incorporated herein by reference.

### BACKGROUND OF THE INVENTION

1. Field of the Invention

The present invention relates to an electromagnetic interference filter, and more particularly, to an integrated electromagnetic interference filter having a leakage inductance sufficient to filter differential mode electromagnetic interference by integrating four inductors for interference filtering in one core structure and controlling the coupling degrees between the four inductors for interference filtering.

2. Description of the Related Art

In general, a power supply device, which supplies a driving power required for driving an electronic device satisfying various needs of a user, is necessarily employed in the electronic device.

The power supply device converts commercial AC power into the driving power. During this operation, electromagnetic interference may be generated.

An electromagnetic interference filter may be employed in a power input terminal to which the commercial AC power is inputted, in order to remove the electromagnetic interference. The electromagnetic interference is largely divided into conducted emission and radiated emission, each of which may be again divided into differential mode electromagnetic interference and common mode electromagnetic interference.

Each common mode choke coil is employed in a live line and a neutral line among power input lines to remove the above-described common mode electromagnetic interference, and at least one differential mode choke coil is separately employed to remove the differential mode electromagnetic interference.

However, this causes an increase in product volume due to use of the choke coils for removing electromagnetic interference, resulting in a failure to meet the needs of a user desiring slim, small electronic equipments.

### SUMMARY OF THE INVENTION

The present invention provides an integrated electromagnetic interference filter having a leakage inductance sufficient to filter the differential mode electromagnetic interference by integrating four inductors for interference filtering in one core structure and controlling the coupling degree between the four inductors for interference filter.

According to an aspect of the present invention, there is provided an integrated electromagnetic interference filter, comprising: a core part including at least first and second leg parts, and first and second cores electromagnetically coupled with each other by the first and second leg parts; a bobbin part including first, second, third, and fourth bobbins each having a penetration hole, into which the leg part is inserted, and a winding region, which is defined as the outer circumferential surface surrounding the penetration hole, the first and second leg parts being inserted into the penetration holes of two respective bobbins of the first to fourth bobbins; and a winding part having first, second, third, and fourth winding wires respectively wound around the first, second, third, and fourth bobbins to remove electromagnetic interference included in power transmitted from a power line.

The first bobbin and the second bobbin may be laminated such that the first leg part is inserted into the penetration holes of the first bobbin and the second bobbin, and the third bobbin and the fourth bobbin may be laminated such that the second leg part is inserted into the penetration holes of the third bobbin and the fourth bobbin.

The first winding wire may be wound on the winding region of the first bobbin, one end of the first winding wire being electrically connected to a live terminal among power input terminals and the other end of the first winding wire being electrically connected to one end of the third winding wire; the third winding wire may wound on the winding region of the third bobbin, the other end of the third winding wire being electrically connected to an external circuit; the second winding wire may be wound on the winding region of the second bobbin, one end of the second winding wire being electrically connected to a neutral terminal among the power input terminals and the other end of the second winding wire being electrically connected to one end of the fourth winding wire; and the fourth winding wire may be wound on the winding region of the fourth bobbin, the other end of the fourth winding wire being electrically connected to the external circuit.

The first winding wire and the second winding wire may have the same winding direction and the third winding wire and the fourth winding wire may have the same winding direction.

The core part may further include a third leg part forming a magnetic flux path between the first leg part and the second leg part.

The first and second cores may be EE cores, EI cores, UU cores, or CI cores,

According to another aspect of the present invention, the first winding wire may be wound on the winding region of the first bobbin, one end of the first winding wire being electrically connected to a live terminal among power input terminals and the other end of the first winding wire being electrically connected to one end of the second winding wire; the second winding wire may be wound on the winding region of the second bobbin, the other end of the second winding wire being electrically connected to an external circuit; the third winding wire may be wound on the winding region of the third bobbin, one end of the third winding wire being electrically connected to a neutral terminal among the power input terminals and the other end of the third winding wire being electrically connected to one end of the fourth winding wire; and the fourth winding wire may be wound on the winding region of the fourth bobbin, the other end of the fourth winding wire being electrically connected to the external circuit.

The first winding wire and the third winding wire may have the same winding direction and the second winding wire and the fourth winding wire may nave the same winding direction.

According to another aspect of the present invention, the first winding wire may be wound on the winding region of the first bobbin, one end of the first winding wire being electrically connected to a live terminal among power input terminals and the other end of the first winding wire being electrically connected to one end of the second winding wire; the second winding wire may be wound on the winding region of the second bobbin, the other end of the second winding wire being electrically connected to an external circuit; the fourth winding wire may be wound on the winding region of the fourth bobbin, one end of the fourth winding wire being electrically connected to a neutral terminal among the power input terminals and the other end of the fourth winding wire being electrically connected to one end of the third winding wire; and the third winding wire may be wound on the winding region of the third bobbin, the other end of the third winding wire being electrically connected to the external circuit.

The first winding wire and the fourth winding wire may have the same winding direction and the second winding wire and the third winding wire may have the same winding direction.

According to another aspect of the present invention, the first bobbin may be inserted into the penetration hole of the second bobbin and the first leg part may be inserted into the penetration hole of the first bobbin; and the third bobbin may be inserted into the penetration hole of the fourth bobbin and the second leg part may be inserted into the penetration hole of the third bobbin.

According to the present invention, four inductors for interference filtering are integrated in one core structure and the coupling degree between the four inductors for interference filtering is controlled. As a result, a leakage inductance sufficient to filter the differential mode electromagnetic interference as well as the common mode electromagnetic interference may be generated, thereby reducing the circuit area and the manufacturing costs.

### BRIEF DESCRIPTION OF THE DRAWINGS

The above and other aspects, features and other advantages of the present invention will be more clearly understood from the following detailed description taken in conjunction with the accompanying drawings, in which;

FIG. 1 is an exploded perspective view of an electromagnetic interference filter according to a first embodiment of the present invention;

FIG. 2 is a schematic perspective view of the electromagnetic interference filter shown in FIG. 1;

FIG. 3 is an exploded perspective view of an electromagnetic interference filter according to a second embodiment of the present invention;

FIG. 4 is a schematic perspective view of the electromagnetic interference filter shown in FIG. 3;

FIG. 5 is a schematic circuit diagram of the electromagnetic interference filter according to the first or second embodiment of the present invention;

FIG. 6 and FIG. 7 are schematic circuit diagrams of a magnetic interference filter according to another embodiment of the present invention;

FIG. 8 to FIG. 10 are graphs showing electric characteristics of the electromagnetic interference filters shown in FIG. 5 to FIG. 7; and

FIG. 11 and FIG. 12 are a schematic cutaway view and a cross-sectional view of a display device employing an electromagnetic interference filter according to an embodiment of the present invention.

### DETAILED DESCRIPTION OF THE PREFERRED EMBODIMENT

Exemplary embodiments of the present invention will now be described in detail with reference to the accompanying drawings so that they could be easily practiced by those skilled in the art to which the present invention pertains. However, in describing the exemplary embodiments of the present invention, detailed descriptions of well-known functions or constructions will be omitted so as not to obscure the description of the present invention with unnecessary detail.

In addition, like reference numerals denote like elements throughout the drawings.

Hereinafter, the preferred embodiments of the present invention will be described in detail with reference to the accompanying drawings.

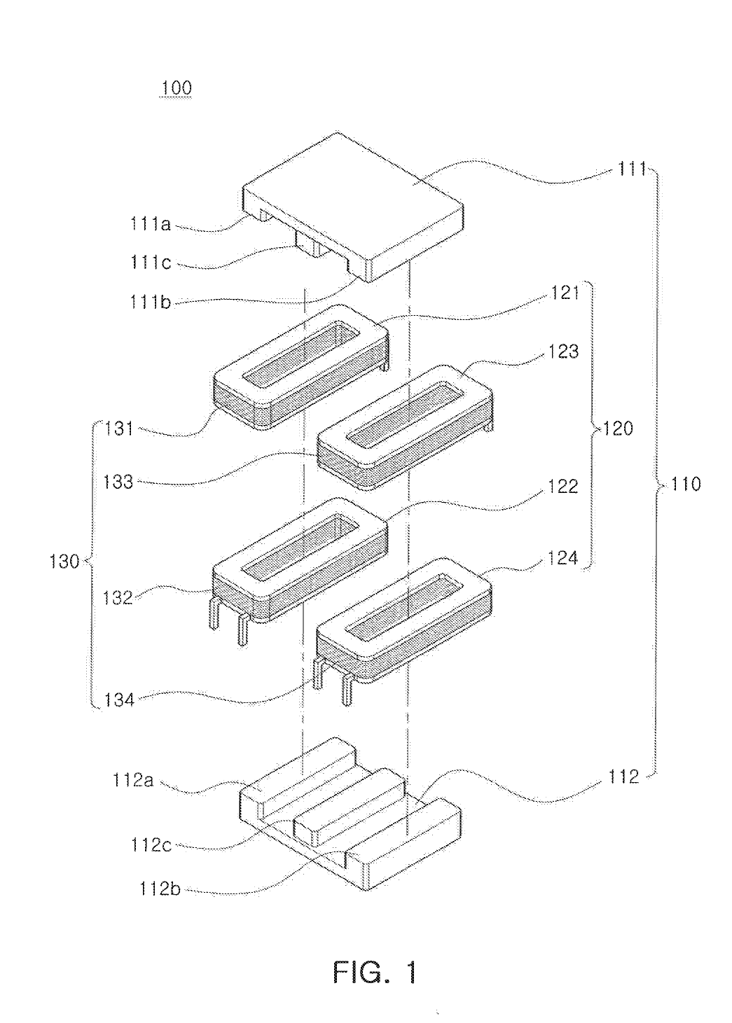

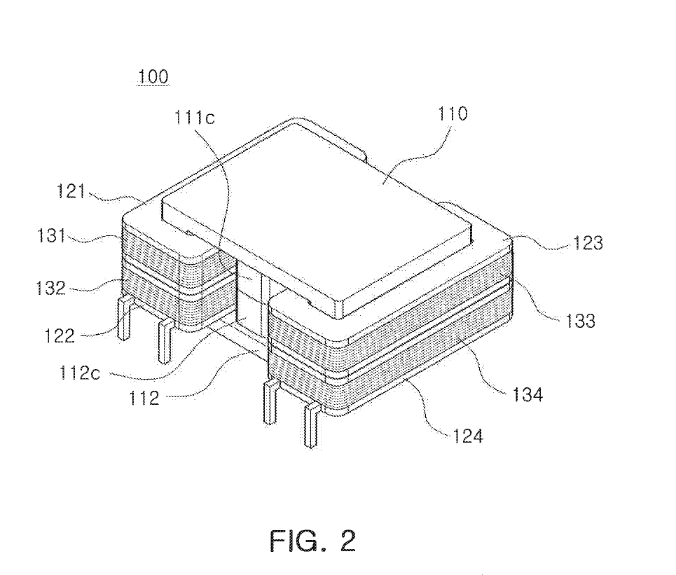

FIG. 1 is an exploded perspective view of an electromagnetic interference filter according to a first embodiment of the present invention, and FIG. 2 is a schematic perspective view of the electromagnetic interference filter shown in FIG. 1.

Referring to FIG. 1 and FIG. 2, an electromagnetic interference filter 100 according to a first embodiment of the present invention may include a core part 110, a bobbin part 120, and a winding part 130. The core part 110 may include a first core 111 and a second core 112 electromagnetically coupled with each other. The first core 111 and the second core 112 may be EE cores or EI cores. As the EE core and the EI core have the same coupling type, the core part 110 of the present embodiment will be focused on the EE core. The first core 111 and the second core 112 are electromagnetically coupled with each other by first to third leg parts. The first to third leg parts may be formed by respectively coupling first to third protrusions 111a, 111b, and 111c protruded from the first core 111 and fourth to sixth protrusions 112a, 112b, and 112c protruded from the second core 112, each other. In other words, the first leg part may be formed by coupling the first protrusion 111a to the fourth protrusion 112a, the second leg part may be formed by coupling the second protrusion 111b to the fifth protrusion 112b, and the third leg part may be formed by coupling the third protrusion 111c to the sixth protrusion 112c.

The bobbin part 120 and the winding part 130 may be formed between the first core 111 and the second core 112.

The bobbin part 120 may include first, second, third, and fourth bobbins 121, 122, 123, and 124. The first and second bobbins 121 and 122 are laminated while the third and fourth bobbins 123 and 124 are laminated, according to the type of embodiment. A penetration hole is formed in each of the first to fourth bobbins 121 to 124. A winding region in which a coil is wound is prepared on the outer circumferential surface surrounding the penetration hole. The first leg part may be inserted into the penetration hole of the stacked first and second bobbins 121 and 122. The second leg part may be inserted into the penetration hole of the stacked third and fourth bobbins 123 and 124. The third leg part may be disposed between the first leg part and the second leg part to form a magnetic flux path. First, second, third, and fourth winding wires may be wound on the winding regions of the first, second, third, and fourth bobbins 121, 122, 123, and 124, respectively.

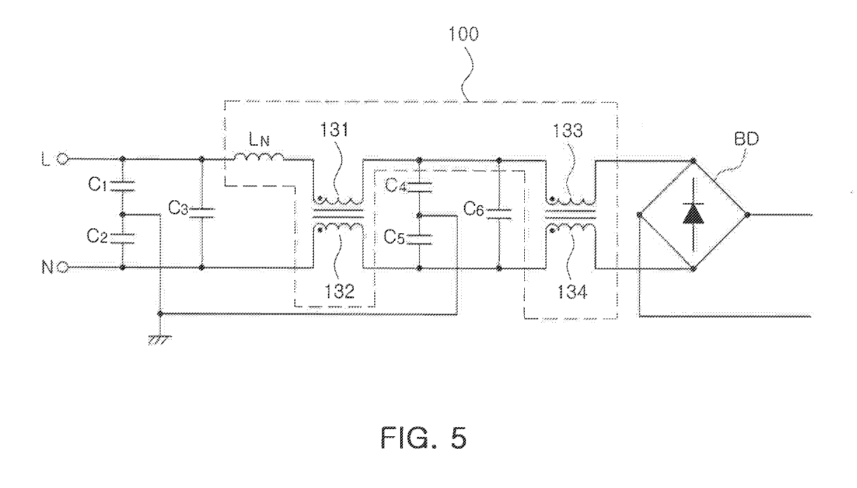

The winding part 130 may include the first, second, third, and fourth winding wires 131, 132, 133, and 134. For example, the first, second, third, and fourth winding wires 131, 132, 133 and 134 are wound on the winding regions of the first, second, third, and fourth bobbins 121, 122, 123, and 124, respectively, thereby functioning as inductors. As a result, electromagnetic interference included in power transmitted through a power line may be removed. The winding connection relation of the bobbins will be described in detail with reference to FIG. 5 to FIG. 7.

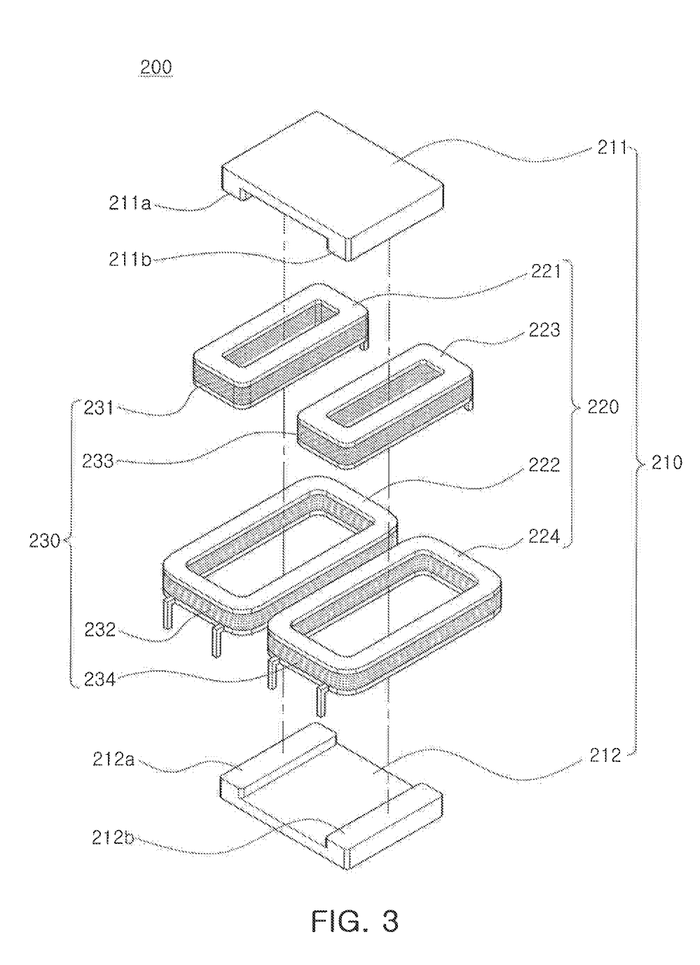

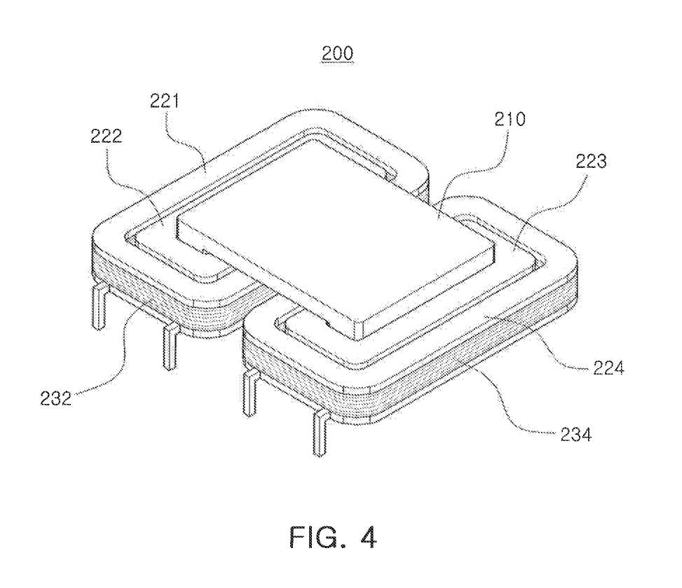

FIG. 3 is an exploded perspective view of an electromagnetic interference filter according to a second embodiment of the present invention, and FIG. 4 is a schematic perspective view of the electromagnetic interference filter shown in FIG. 3.

Referring to FIG. 3 and FIG. 4, an electromagnetic interference filter according to the second embodiment of the present invention may be compared with the electromagnetic interference filter according to the first embodiment of the present invention shown in FIG. 1 and FIG. 2. Core part 210 may include a first core 211 and a second core 212 electromagnetically coupled with each other. The first core 211 and the second core 212 may be UU cores or CI cores. As the UU core and the CI core have the same coupling type, the core part 210 of the present embodiment will be focused on the UU core. The first core 211 and the second core 212 may be electromagnetically coupled with each other by first and second leg parts. The first leg part may be formed by coupling a first protrusion 211a to a third protrusion 212a, and the second leg part may be formed by coupling a second protrusion 211b to a fourth protrusion 212b.

A bobbin part 220 and a winding part 230 may be provided between the first core 211 and the second core 212.

The bobbin part 220 may include first, second, third, and fourth bobbins 221, 222, 223, and 224 each having a penetration hole. According to the type of embodiment, the first leg part of the core part 210 may be inserted into the penetration hole of the first bobbin 221, and the first bobbin 221 may be inserted into the penetration hole of the second bobbin 222. In addition, the second leg part of the core part 210 may be inserted into the penetration hole of the third bobbin 223, and the third bobbin 223 may be inserted into the penetration hole of the fourth bobbin 224.

The winding part 230 may include first, second, third, and fourth winding wires 231, 232, 233, and 234. For example, the first, second, third, and fourth winding wires 231, 232, 233 and 234 may be wound on the winding regions of the first, second, third, and fourth bobbins 221, 222, 223, and 224, respectively, thereby functioning as inductors. As a result, electromagnetic interference included in power transmitted through a power line may be removed. The winding connection of the bobbins will be described in detail with reference to FIG. 5 to FIG. 7.

FIG. 5 is a schematic circuit diagram of the electromagnetic interference filter according to the first or second embodiment of the present invention.

Referring to FIG. 5, the connection relation of the first to fourth winding wires 131, 132, 133, and 134 in the electromagnetic interference filter shown in FIG. 1 to FIG. 4 according to the first or second embodiments of the present invention is described. As the electromagnetic interference filters according to the first and second embodiments of the present invention have the same connection relation between the winding wires, but different structures of bobbins, the connection relation between the winding wires will be described based on the electromagnetic interference filter 100 according to the first embodiment of the present invention.

The electromagnetic interference filter 100 according to an embodiment of the present invention is capable of removing electromagnetic interference between power input terminals L and N and a rectifying circuit BD (or a circuit for performing a predetermined operation—not shown) of the rear end portion. As for the first winding wire 131, one end may be connected to a live terminal L among the power input terminals and the other end may be connected to the third winding wire 133. As for the third winding wire 133, one end may be connected to the other end of the first winding wire 131 and the other end thereof may be connected to the rectifying circuit BD of the rear end portion. As for the second winding wire 132, one end may be connected, to a neutral end N among the power input terminals and the other end may be connected to the fourth winding wire 134. As for the fourth winding wire 134, one end may he connected to the other end of the second winding wire 132 and the other end thereof may be connected to the rectifying circuit BD of the rear end portion. As described above, the first to fourth winding wires 131 to 134 may be provided between power paths through which power is transmitted between the power input terminals L and N and the rectifying circuit BD. Therefore, electromagnetic interference generated between the power input terminals L and N and the rectifying circuit BD (or a circuit for performing a predetermined operation—not shown) of the rear end portion, particularly, common mode electromagnetic interference may be removed. In addition, first and second Y capacitors C1 and C2, and third and fourth Y capacitors C4 and C5, also, are able to remove the common mode electromagnetic interference. Differential mode electromagnetic interference of the electromagnetic interferences may be removed by a leakage inductance generated due to the coupling degree between the first winding wire 131 and the second winding wire 132 electromagnetically coupled with the first winding wire 131, and a leakage inductance generated due to the coupling degree between the third winding wire 133 and the fourth winding wire 134 electromagnetically coupled with the third wincing wire 133, even without employing a separate inductor element. That is, the first bobbin 121 wound with the first winding wire 131 and the second bobbin 122 wound with the second winding wire 132 may be laminated, or inserted into the penetration hole, to decrease the coupling degree, thereby significantly increasing the level of the leakage inductance. The same goes for a case of the third winding wire 133 and the fourth winding wire 134.

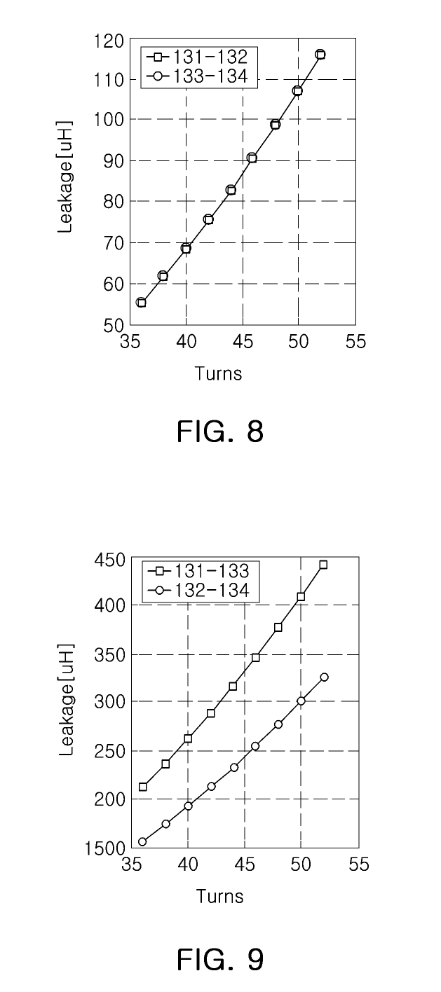

Referring to FIG. 8, it can be seen that the leakage inductance, which is generated by the electromagnetic interference filter according to the first or second embodiment of the present invention, increases sufficiently to remove the differential mode electromagnetic interference, and that the leakage inductance gradually increases with the increase in the number of winding (or turns).

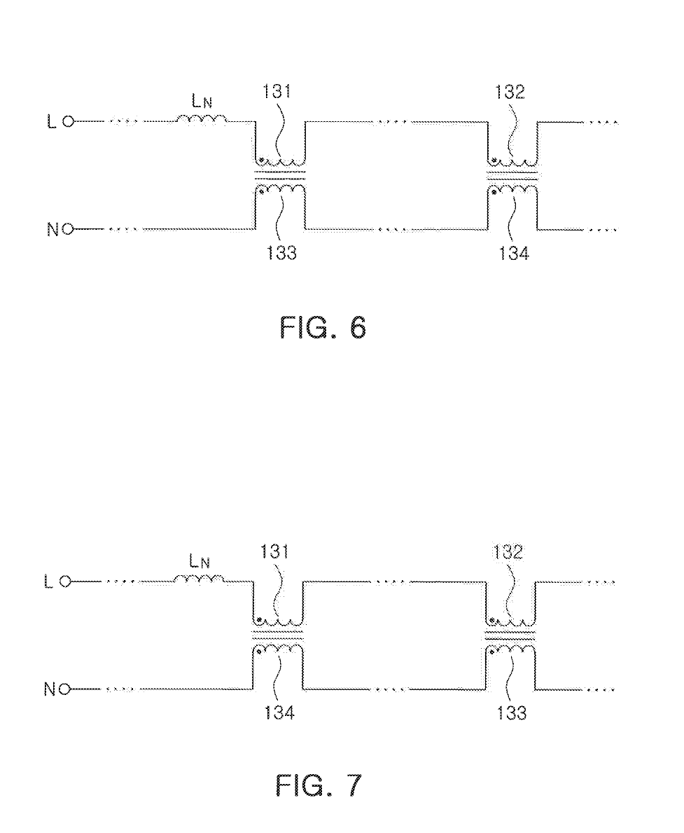

FIG. 6 and FIG. 7 are schematic circuit diagrams of a magnetic interference filter according to another embodiment of the present invention. In other words, the electromagnetic interference filter according to the embodiment of the present invention is capable of adjusting the level of the leakage inductance by varying the connection relation between winding wires wound around respective bobbins to control the coupling degree between the winding wires electromagnetically coupled with each other.

Referring to FIG. 6, the electromagnetic interference filter according to the embodiment of the present invention is capable of controlling the coupling degree between the winding wires, by laminating the first bobbin on the second bobbin and laminating the third bobbin on the fourth bobbin, or inserting the first bobbin into the penetration hole of the second bobbin and inserting the third bobbin into the penetration hole of the fourth bobbin. However, the coupling degree may be controlled through the connection relation of the winding wires in a stare where the bobbins are laminated, or inserted into the penetration holes. In other words, in the electromagnetic interference filter 100 according to the first embodiment of the present invention, the first winding wire 131 and the third winding wire 133 may be electromagnetically coupled with each other, and the second winding wire 132 and the fourth winding wire 134 may be electromagnetically coupled with each other. Describing more in detail, as for the first winding wire 131, one end may be connected to a live terminal L among the power input terminals and the other end may be connected to the second wining wire 132. As for the second winding wire 132, one end may be connected to the other end of the first winding wire 131 and the other end thereof may be connected to the rectifying circuit BD of the rear end portion. As for the third winding wire 133, one end may be connected to the neutral end N among the power input terminals and the other end may be connected to the fourth winding wire 134. As for the fourth winding wire 134, one end may be connected to the other end of the third winding wire 133 and the other end may be connected to the rectifying circuit BD of the rear end portion.

Referring to FIG. 9, it can be seen that the level of leakage inductance due to an electromagnetic coupling between the first winding wire 131 and the third winding wire 133 and the level of leakage inductance due to an electromagnetic coupling between the second winding wire 132 and the fourth winding wire 134 significantly increase. In addition, it can be seen that the level of leakage inductance due to electromagnetic coupling between the first winding wire 131 and the third winding wire 133 and the level of leakage inductance due to an electromagnetic coupling between the second winding wire 132 and the fourth winding wire 134 may be set differently from each other.

Referring to FIG. 7, in the electromagnetic interference filter 100 according to the first embodiment of the present invention, the first winding wire 131 and the fourth winding wire 134 may be electromagnetically coupled with each other, and the second winding wire 132 and the third winding wire 133 may be electromagnetically coupled with each other. More particularly, as for the first winding wire 131, one end may be connected to a live terminal L among the power input terminals and the other end may be connected to the second wining wire 132. As for the second winding wire 132, one end may be connected to the other end of the first winding wire 131 and the other end may be connected to the rectifying circuit BD of the rear end portion. As for the fourth winding wire 134, one end may be connected to the neutral end N among the power input terminals and the other end may be connected to the third winding wire 133. As for the third winding wire 133, one end may be connected to the other end of the fourth winding wire 134 and the other end may be connected to the rectifying circuit BD of the rear end portion.

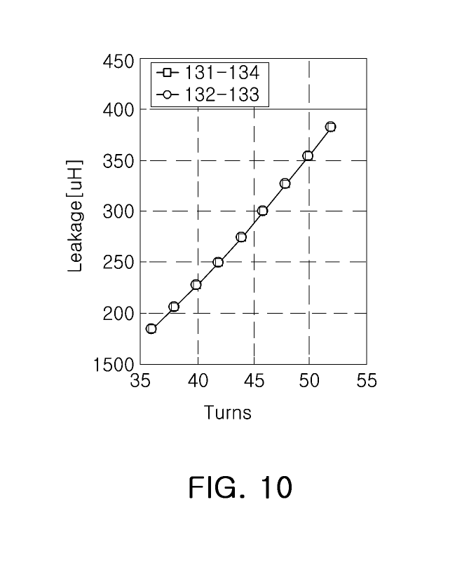

Referring to FIG. 10, it can be seen that the level of leakage inductance due to an electromagnetic coupling between the first winding wire 131 and the fourth winding wire 134 and the level of leakage inductance due to an electromagnetic coupling between the second winding wire 132 and the third winding wire 133 significantly increase.

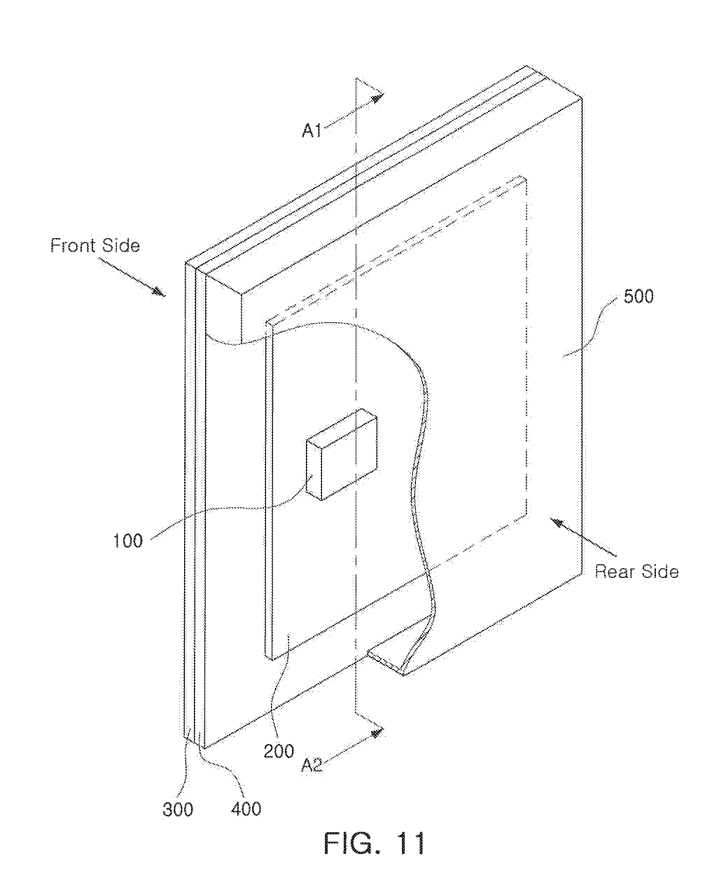

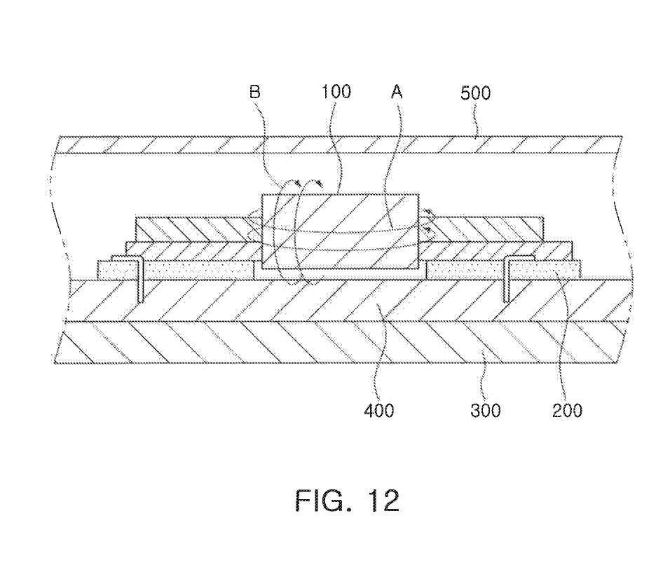

FIG. 11 and FIG. 12 are a schematic cutaway view and a cross-sectional view of a display device employing an electromagnetic interference filter according to an embodiment of the present invention.

Referring to FIG. 11, a display device employing an electromagnetic interference filter according to an embodiment of the present invention may include a panel 300, a backlight unit 400 supporting the panel 300 and including a light source, a circuit board 200 for supplying power to the light source included in the backlight unit 400, the electromagnetic interference filter 100 of the present invention for removing electromagnetic interference of the power transmitted from the circuit board 200, and a back cover 500 combined with the backlight unit 400.

The panel 300 according to the embodiment of the present invention may be an LCD panel, but not limited to the LCD panel.

For example, when the panel 300 is the LCD panel, the backlight unit 400 may include a lamp as a light source, a light guide panel, a plurality of sheets, a lam reflector, a mold frame (or a support main).

Herein, the plurality of sheets may include a reflection sheet, a diffusion sheet, a prism sheet, and a protection sheet.

Meanwhile, a light emitting diode (LED) may be used as the light source of the backlight unit 400 according to the embodiment of the present invention. The circuit board 200 may include not only the electromagnetic interference filter 100 according to the embodiment of the present invention but power devices, power components and power-related circuits required for supplying power to the display device of the present invention.

A cavity may be formed in the circuit board 200 to receive at least a portion of the electromagnetic interference filter 100. A portion of the core part 110 of the electromagnetic interference filter 100 may be received in the cavity. The core part 110 may transmit power to the circuit board 200 or receive the power from the circuit board 200 by pins. The core part 110 may be fixed by the pins.

Referring to FIG. 12, as for the electromagnetic interference filter 100 according to an embodiment of the present invention, a pair of cores is vertically coupled with each other and the winding wires are horizontally wound around bobbins between the cores. As a result, a direction of the magnetic flux is mainly a horizontal direction, as depicted by identification letter A. The magnetic flux having a direction like an identification letter B is capable of suppressing the formation of magnetic field by the cores. Thus, the electromagnetic interference between the electromagnetic interference filter 100 of the present invention and the back cover 500 may be suppressed without employing separate shielding equipment. In addition, low-frequency noise due to the electromagnetic interference between the electromagnetic interference filter 100 of the present invention and the back cover 500 may be prevented.

As described above, the embodiment of the present invention is capable of increasing a leakage inductance, thereby removing common mode electromagnetic interference, by integrating four inductors in one core structure and laminating bobbins, around which inductor winding wires are respectively wound, or inserting the bobbins into penetration holes to control the coupling degree between the inductors. Further, the present invention is capable of easily removing differential mode electromagnetic interference even without separately employing inductors for removing the differential mode electromagnetic interference. Further, the present invention is capable of increasing the leakage inductance more largely by varying the connection relation between the inductor winding wires to control the coupling degree further. Therefore, the present, invention is capable of reducing the circuit area and the manufacturing costs.

In addition, according to the present invention, the production efficiency may be improved and the manufacturing costs may be reduced by winding one or more winding wires of an electromagnetic interference filter around the bobbins to allow automatic winding. Further, low-frequency noise due to the interference between magnetic fields generated from a metallic back cover and an electromagnetic interference coil may be prevented according to an embodiment of the present invention when the electromagnetic interference coil is employed in an electronic device, particularly, a display device, by forming a direction of magnetic flux to be mainly a horizontal direction.

As described above, the present invention is not limited by the above-described embodiments and the accompanying drawing, but by claims which will be described below. It will be easily understood by those skilled in the art that constitutions of the present invention can be variously changed and modified within the range of technical spirits of the present invention.

What is claimed is:

1. An integrated electromagnetic interference filter, comprising:
a core part including at least first and second leg parts, and first and second cores electromagnetically coupled with each other by the first and second leg parts;
a bobbin part including first, second, third, and fourth bobbins, each having a penetration hole, into which the leg part is inserted, and a winding region, which is defined, as an outer circumferential surface surrounding the penetration hole, the first and second leg parts being inserted into the penetration holes of two respective bobbins of the first to fourth bobbins; and
a winding part having first, second, third, and fourth winding wires respectively wound around the first, second, third, and fourth bobbins to remove electromagnetic interference included in power transmitted from a power line.

2. The integrated electromagnetic interference filter of claim 1, wherein the first bobbin and the second bobbin are laminated such that the first leg part is inserted into the penetration holes of the first bobbin and the second bobbin, and the third bobbin and the fourth bobbin are laminated such that the second leg part is inserted into the penetration holes of the third bobbin and the fourth bobbin.

3. The integrated electromagnetic interference filter of claim 2, wherein the first winding wire is wound on the winding region of the first bobbin, one end of the first winding wire being electrically connected to a live terminal among power input terminals and the other end of the first winding wire being electrically connected to one end of the third winding wire; wherein the third winding wire is wound on the winding region of the third bobbin, the other end of the third winding wire being electrically connected to an external circuit; wherein the second winding wire is wound on the winding region of the second bobbin, one end of the second winding wire being electrically connected to a neutral terminal among the power input terminals and the other end of the second winding wire being electrically connected to one end of the fourth winding wire; and wherein the fourth winding wire is wound on the winding region of the fourth bobbin, the other end of the fourth winding wire being electrically connected to the external circuit.

4. The integrated electromagnetic interference filter of claim 3, wherein the first winding wire and the second winding wire have the same winding direction and the third winding wire and the fourth winding wire have the same winding direction.

5. The integrated electromagnetic interference filter of claim 2, wherein the core part further includes a third leg part forming a magnetic flux path between the first leg part and the second leg part.

6. The integrated electromagnetic interference filter of claim 2, wherein the first winding wire is wound on the winding region of the first bobbin, one end of the first winding wire being electrically connected to a live terminal among power input terminals and the other end of the first winding wire being electrically connected to one end of the second winding wire; wherein the second winding wire is wound on the winding region of the second bobbin, the other end of the second winding wire being electrically connected to an external circuit; wherein the third winding wire is wound on the winding region of the third bobbin, one end of the third winding wire being electrically connected to a neutral terminal among the power input terminals and the other end of the third winding wire being electrically connected to one end of the fourth winding wire; and wherein the fourth winding wire is wound on the winding region of the fourth bobbin, the other end of the fourth winding wire being electrically connected to the external circuit.

7. The integrated electromagnetic interference filter of claim 6, wherein the first winding wire and the third winding wire have the same winding direction and the second winding wire and the fourth winding wire nave the same winding direction.

8. The integrated electromagnetic interference filter of claim 2, wherein the first winding wire is wound on the winding region of the first bobbin, one end of the first winding wire being electrically connected to a live terminal among power input terminals and the other end of the first winding wire being electrically connected to one end of the second winding wire; wherein the second winding wire is wound on the winding region of the second bobbin, the other end of the second winding wire being electrically connected to an external circuit; wherein the fourth winding wire is wound on the winding region of the fourth bobbin, one end of the fourth winding wire being electrically connected to a neutral terminal among the power input terminals and the other end of the fourth winding wire being electrically connected to one end of the third winding wire; and wherein the third winding wire is wound on the winding region of the third bobbin, the other end of the third winding wire being electrically connected to the external circuit.

9. The integrated electromagnetic interference filter of claim 8, wherein the first winding wire and the fourth winding wire have the same winding direction and the second winding wire and the third winding wire have the same winding direction.

10. The integrated electromagnetic interference filter of claim 1, wherein the first bobbin is inserted into the penetration hole of the second bobbin and the first leg part is inserted into the penetration hole of the first bobbin; and wherein the third bobbin is inserted into the penetration hole of the fourth bobbin and the second leg part is inserted into the penetration hole of the third bobbin.

11. The integrated electromagnetic interference filter of claim 10, wherein the first winding wire is wound on the winding region of the first bobbin, one end of the first winding wire being electrically connected to a live terminal among power input terminals and the other end of the first winding wire being electrically connected to one end of the third winding wire; wherein the third winding wire is wound on the winding region of the third bobbin, the other end of the third winding wire being electrically connected to an external circuit; wherein the second winding wire is wound on the winding region of the second bobbin, one end of the second winding wire being electrically connected to a neutral terminal among the power input terminals and the other end of the second winding wire being electrically connected to one end of the fourth winding wire; and wherein the fourth winding wire is wound on the winding region of the fourth bobbin, the other end of the fourth winding wire being electrically connected to the external circuit.

12. The integrated electromagnetic interference filter of claim 11, wherein the first winding wire and the second winding wire have the same winding direction and the third winding wire and the fourth winding wire have the same winding direction.

13. The integrated electromagnetic interference filter of claim 10, wherein the first winding wire is wound on the winding region of the first bobbin, one end of the first winding wire being electrically connected to a live terminal among power input terminals and the other end of the first winding wire being electrically connected to one end of the second winding wire; wherein the second winding wire is wound on the winding region of the second bobbin, the other end of the second winding wire being electrically connected to an external circuit; wherein the third winding wire is wound on the winding region of the third bobbin, one end of the third winding wire being electrically connected to a neutral terminal among the power input terminals and the other end of the third winding wire being electrically connected to one end of the fourth winding wire; and wherein the fourth winding wire is wound on the winding region of the fourth bobbin, the other end of the fourth winding wire being electrically connected to the external circuit.

14. The integrated electromagnetic interference filter of claim 13, wherein the first winding wire and the third winding wire have the same winding direction and the second winding wire and the fourth winding wire have the same winding direction.

15. The integrated electromagnetic interference filter of claim 10, wherein the first winding wire is wound on the winding region of the first bobbin, one end of the first winding wire being electrically connected to a live terminal among power input terminals and the other end of the first winding wire being electrically connected to one end of the second winding wire; wherein the second winding wire is wound on the winding region of the second bobbin, the other end of the second winding wire being electrically connected to an external circuit; wherein the fourth winding wire is wound on the winding region of the fourth bobbin, one end of the fourth winding wire being electrically connected to a neutral terminal among the power input terminals and the other end of the fourth winding wire being electrically connected to one end of the third winding wire; and wherein, the third winding wire is wound on the winding region of the third bobbin, the other end of the third winding wire being electrically connected to the external circuit.

16. The integrated electromagnetic interference filter of claim 15, wherein the first winding wire and the fourth winding wire have the same winding direction and the second winding wire and the third winding wire have the same winding direction.

17. The integrated electromagnetic interference filter of claim 1, wherein the first and second cores are EE cores, EI cores, UU cores, or CI cores.
